(19) United States
(12) Patent Application Publication
(10) Pub. No.: US 2021/0387907 A1
(43) Pub. Date: Dec. 16, 2021

(54) METHOD AND APPARATUS FOR MACHINING GLASS WITH LASER INDUCED CHEMICAL REACTION

(71) Applicant: JPT Electronics Pte Ltd, Singapore (SG)

(72) Inventor: Quoc Huy LAM, Singapore (SG)

(73) Assignee: JPT Electronics Pte Ltd, Singapore (SG)

(21) Appl. No.: 17/341,701

(22) Filed: Jun. 8, 2021

Related U.S. Application Data
(60) Provisional application No. 62/705,178, filed on Jun. 15, 2020.

(51) Int. Cl. C03C 23/00; C03C 15/00; B23K 26/402; B23K 26/03

(52) U.S. Cl. CPC C03C 23/0025; C03C 15/00; G02B 26/105; B23K 26/034; B23K 26/402

(57) ABSTRACT

The present discloses provides a method to cut and chamfer glass or glass-like workpieces such as glass, quartz, glass-ceramic or sapphire in one operation or process. The workpiece is cut and chamfered to arbitrary shapes by the same process without the need to separate cutting process and chamfering process. In the present disclosure, the workpiece material is selectively removed through a fast chemical reaction induced by locally heating using a laser beam.

### CROSS-REFERENCE TO RELATED APPLICATIONS

This application claims priority to U.S. provisional application No. 62/705,178 filed on 15 Jun. 2020, the disclosure of which is incorporated herein by reference in its entirety.

### FIELD OF INVENTION

The present disclosure relates to laser machining glass or glass-like workpieces. In particular it relates to laser machining workpieces with arbitrary shapes of chamfers and cuts in a single manufacturing process or without requiring separate cutting and chamfering processes.

### TECHNICAL BACKGROUND

Cutting glass panel into different shapes is highly demanded in many applications such as automobile, architecture and consumer electronics. However, glass cutting leaves micro cracks and chips at edges which reduce the glass strength and make it easily broken. Chamfered edges are desirable in glass machining because they resist chipping, strengthen glass and eliminate sharp edges. In some applications, it is required that the glass is cut and chamfered to arbitrary shapes.

Machining glass to have arbitrary cuts and chamfers is time consuming since it involves two processes: cutting and chamfering which is normally a slow process.

In view of the above and other issues, there is a need to improve cutting and chamfering processes.

### SUMMARY OF INVENTION

According to an aspect of the invention, a workpiece processing method is provided and comprises:

producing at least one first edge at a workpiece, which is glass or glass-like, by:

providing a first alkaline chemical on a first area on a first side of the workpiece; and

heating the first alkaline chemical at the first area to a first reaction temperature using irradiation of a first laser light, thereby inducing a first chemical reaction between the first alkaline chemical and the workpiece at the first area and causing removal of a first portion of the first area to produce the at least one first edge.

In an embodiment, the first reaction temperature is between 900 degree Celsius and 1000 degree Celsius.

In an embodiment, the at least one first edge separates the workpiece into a plurality of smaller workpieces.

In an embodiment, heating the first alkaline chemical at the first area to a first reaction temperature using irradiation of a first laser light includes irradiating the first laser light based on a predetermined irradiation profile which defines at least one irradiation parameter, including laser irradiation exposure duration and/or laser power, for each of a plurality of positions within the first area, wherein the predetermined irradiation profile is configured to produce a predetermined shape at the at least one first edge.

In an embodiment, producing the at least one first edge at the workpiece further includes ascertaining a dimension of the at least one first edge, and the method further comprises:

if the ascertained dimension of the at least one first edge is below a predetermined dimension value, repeating the step(s) of producing the at least one first edge at the first area of the workpiece to increase the dimension of the at least one first edge.

In an embodiment, producing the at least one first edge at the workpiece further includes clearing the first portion away from the workpiece.

In an embodiment, after producing the at least one first edge at the workpiece, the method further comprising:

producing at least one second edge at the workpiece by:

providing a second alkaline chemical on a second area on a second side of the workpiece; and

heating the second alkaline chemical at the second area to a second reaction temperature using irradiation of a second laser light, thereby inducing a second chemical reaction between the second alkaline chemical and the workpiece at the second area and causing removal of a second portion of the second area to produce the at least one second edge.

In an embodiment, the at least one first edge and the at least one second edge separate the workpiece into a plurality of smaller workpieces.

In an embodiment, the first alkaline chemical and the second alkaline chemical are same.

In an embodiment, the workpiece includes quartz, glass-ceramic, or sapphire.

In an embodiment, the at least one first edge includes a chamfer, a bevel, a groove, and/or a hole.

In an embodiment, heating the first alkaline chemical at the first area to a first reaction temperature using irradiation of a first laser light includes one of the following:

using at least one mirror, steering the first laser light over the first area of the workpiece to shape the at least one first edge;

shaping the first laser light to produce a shaped first laser beam and irradiating the shaped first laser beam at the workpiece to shape the at least one first edge; and

translating the workpiece relative to the first laser light to shape the at least one first edge.

In an embodiment, providing the first alkaline chemical on the first are on the first side of the workpiece includes immersing the workpiece in the first alkaline chemical.

According to an aspect of the invention, a workpiece processing system comprising:

a chemical reservoir configured to provide a first alkaline chemical on a first area on a first side of a workpiece, which is glass or glass-like;

a laser irradiation apparatus configured to irradiate a first laser light on the first alkaline chemical at the first area, wherein the first laser light is configured to heat the first alkaline chemical at the first area to a first reaction temperature to induce a first chemical reaction between the first alkaline chemical and the workpiece at the first area, wherein the first chemical reaction is to cause removal of a first portion of the first area to produce the at least one first edge; and

a workpiece handler configured to arrange the first side of the workpiece within operational reach of the chemical reservoir and the laser irradiation apparatus.

In an embodiment, the first reaction temperature is between 900 degree Celsius and 1000 degree Celsius.

In an embodiment, the at least one first edge separates the workpiece into a plurality of smaller workpieces.

In an embodiment, the system further comprises:

a process controller communicably coupled to the laser irradiation apparatus and configured to operate the first laser light based on a predetermined irradiation profile which defines at least one irradiation parameter, including laser irradiation exposure duration and/or laser power, for each of a plurality of positions within the first area, wherein the predetermined irradiation profile is configured to produce a predetermined shape at the at least one first edge.

In an embodiment, the system further comprises:

a measurement apparatus communicably coupled to the process controller and configured to ascertain a dimension of the at least one first edge and transmit the ascertained dimension to the process controller;

wherein the process controller is configured to cause the chemical reservoir and the laser irradiation apparatus to repeat production of the at least one first edge at the first area to increase the dimension of the at least one first edge if the ascertained dimension of the at least one first edge is below a predetermined dimension.

In an embodiment, the system further comprises:

a disposal apparatus communicably coupled to the process controller and wherein the process controller is configured to cause the disposal apparatus to clear the first portion away from the workpiece if the ascertained dimension of the at least one first edge is below a predetermined dimension.

In an embodiment, the workpiece handler is further configured to arrange a second side of the workpiece within operational reach of the chemical reservoir and the laser irradiation apparatus,

wherein the chemical reservoir is configured to provide a second alkaline chemical on a second area on the second side of the workpiece,

wherein the laser irradiation apparatus is configured to irradiate a second laser light on the second alkaline chemical at the second area, wherein the second laser light is configured to heat the second alkaline chemical at the second area to a second reaction temperature to induce a second chemical reaction between the second alkaline chemical and the workpiece at the second area, wherein the second chemical reaction is to cause removal of a second portion of the second area to produce the at least one second edge which adjoins the at least one first edge.

In an embodiment, the at least one first edge and the at least one second edge separate the workpiece into a plurality of smaller workpieces.

In an embodiment, the first alkaline chemical and the second alkaline chemical are same.

In an embodiment, the system further comprises:

a thermal sensor communicably coupled to the process controller and configured to ascertain a temperature of the first alkaline chemical at the first area and transmit the ascertained temperature reading to the process controller,

wherein the process controller is configured to control the laser irradiation apparatus according to the ascertained temperature reading relative to the first reaction temperature.

In an embodiment, the workpiece includes quartz, glass-ceramic, or sapphire.

In an embodiment, the at least one first edge includes a chamfer, a bevel, a groove, and/or a hole.

In an embodiment, the laser irradiation apparatus includes one of the following:

a mirror apparatus configured to steer the first laser light over the first area of the workpiece to shape the at least one first edge;

an optical imaging apparatus configured to shape the first laser light to produce a shaped first laser beam and irradiate the shaped first laser beam at the workpiece to shape the at least one first edge; and

a motorised staging apparatus configured to translate the workpiece relative to the first laser light to shape the at least one first edge.

In an embodiment, the chemical reservoir is provided in a receptacle which is configured to allow the workpiece to be immersed in the first alkaline chemical.

### BRIEF DESCRIPTION OF THE DRAWINGS

Embodiments of the invention will be described in detail with reference to the accompanying drawings, in which:

FIG. 1 illustrates a setup for processing glass or glass-like workpiece by selective material removal through chemical reaction induced by locally laser heating;

FIG. 2 shows a process for producing a chamfered feature with an arbitrary shape on the workpiece by controlling the laser exposure time position profile;

FIG. 3 shows a process for producing a cut and chamfers at both sides of the workpiece;

FIG. 4 shows a flow chart describing multiple chemical depositing and laser exposure cycles for increasing removal depth;

FIG. 5 is a schematic block diagram of a system for processing glass or glass-like workpiece;

FIG. 6 illustrates a setup for processing glass or glass-like workpiece wherein the setup includes a laser, a chemical dispenser and a thermal camera; and

FIG. 7 illustrates a setup for processing glass or glass-like workpiece, wherein the setup includes a workpiece immerged in a chemical reservoir, a laser, and a thermal camera.

### DETAILED DESCRIPTION OF THE INVENTION

The following detailed description refers to the accompanying drawings that show, by way of illustration, specific details and embodiments in which the invention may be practiced. These embodiments are described in sufficient detail to enable those skilled in the art to practice the invention. Other embodiments may be utilized and structural, logical, and electrical changes may be made without departing from the scope of the invention. The various embodiments are not necessarily mutually exclusive, as some embodiments can be combined with one or more other embodiments to form new embodiments.

Embodiments described in the context of one of the methods or devices are analogously valid for the other methods or devices. Similarly, embodiments described in the context of a method are analogously valid for a device, and vice versa.

Features that are described in the context of an embodiment may correspondingly be applicable to the same or similar features in the other embodiments. Features that are described in the context of an embodiment may correspondingly be applicable to the other embodiments, even if not explicitly described in these other embodiments. Furthermore, additions and/or combinations and/or alternatives as described for a feature in the context of an embodiment may correspondingly be applicable to the same or similar feature in the other embodiments.

As used herein, the articles “a”, “an” and “the” as used with regard to a feature or element include a reference to one or more of the features or elements.

As used herein, the term “and/or” includes any and all combinations of one or more of the associated listed items.

As used herein, the phrase of the form of “at least one of A or B” may include A or B or both A and B. Correspondingly, the phrase of the form of “at least one of A or B or C”, or including further listed items, may include any and all combinations of one or more of the associated listed items.

The terms “comprising,” “including,” and “having” are intended to be open-ended and mean that there may be additional features or elements other than the listed ones.

Identifiers such as “first”, “second” and “third” are used merely as labels, and are not intended to impose numerical requirements on their objects, nor construed in a manner imposing any relative position or time sequence between limitations.

As used herein, the phrases “configured to”, “arranged to”, “adapted to”, “constructed and arranged to” may be used interchangeably.

As used herein, the term “coupled” and related terms are used in an operational sense and are not necessarily limited to a direct physical connection or coupling. Thus, for example, two devices may be coupled directly, or via one or more intermediary devices. In certain examples, devices may be suitably coupled such that information or signal can be passed there between, while not sharing any physical connection with each other. For example, two devices may be communicably coupled via a wired or wireless connection. Based on the present disclosure, a person of ordinary skill in the art will appreciate a variety of ways in which coupling exists in accordance with the aforementioned definition.

According to some embodiments, a workpiece processing method may comprise: producing at least one first edge at a workpiece which is glass or glass-like. Producing at least one first edge at a workpiece comprises: providing a first alkaline chemical on a first area on a first side of the workpiece; and heating the first alkaline chemical at the first area to a first reaction temperature using irradiation of a first laser light, thereby inducing a first chemical reaction between the first alkaline chemical and the workpiece at the first area and causing removal of a first portion of the first area to produce the at least one first edge.

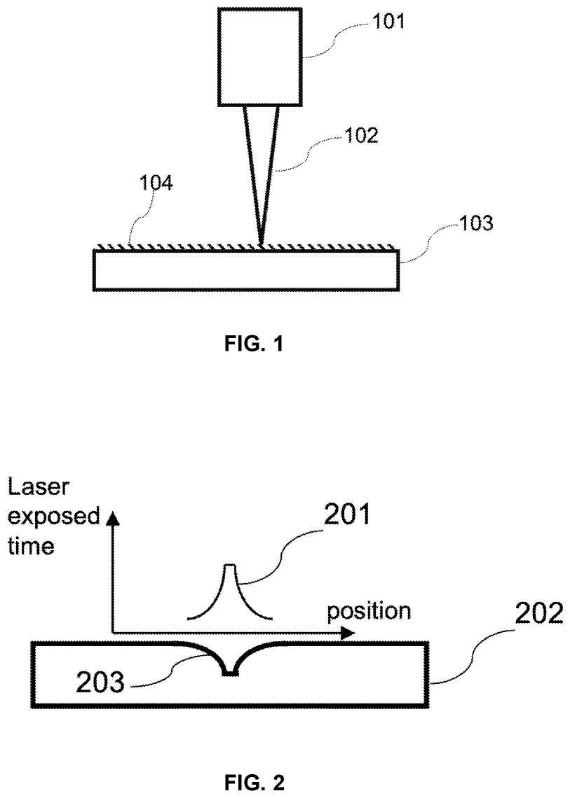

FIG. 1 illustrates an embodiment for processing, e.g., chamfering and cutting, an article or workpiece, e.g., workpiece 103, using laser light irradiation, e.g., a laser beam 102, from laser 101 to heat a chemical 104, e.g., alkaline chemical, to induce a chemical reaction between the chemical 104 and the workpiece 103. The chemical 104 may be deposited on the workpiece 103 surface as a layer having a thickness which may range between 1 micrometre (μm) and several millimetres (mm). At low temperature, e.g., below 900° C. or other temperature lower than a predetermined reaction temperature, the chemical 104 does not react with the workpiece 103 or the reaction is at very low speed which is negligible to the processing time. The laser beam 102 may focus on a selected position or area, and locally heat the chemical 104 and the workpiece 103 at that selected position or area (or hot spot) to reach a reaction temperature, e.g., high temperature of at least 900° C., between 900° C. to 1000° C., or other suitable temperature depending on the chemical used. At that high temperature, a chemical reaction is induced in which the chemical 104 reacts with the workpiece 103 material at the hot spot and dissolves it thereby causing removal of a portion of the workpiece 103 material at the hot spot. The removed portion results in formation of at least one edge at the workpiece 103. The amount and size of the workpiece 103 material which is selectively removed depends on the amount of the hot spot of the chemical 104. By controlling the power, focus spot size and position of the laser beam 102, the amount, size and position of the chemical hot spot may be controlled and thus the amount, size and position of the removed material may be determined.

The workpiece material may be glass, or glass-like such as quartz, glass-ceramic or sapphire.

The chemical may be an alkaline chemical, e.g., sodium hydroxide (NaOH), potassium hydroxide (KOH), or other alkaline chemicals.

The chemical can be provided in solid form, e.g., powder, liquid form, or solution form, e.g., chemical mixed with water at a predetermined concentration.

Some examples of reaction between the chemical and the workpiece material may be represented by the following:

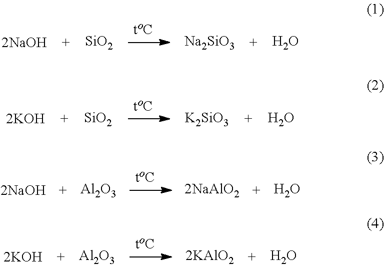

The above reactions are fast acid-base reactions and take place at or above a predetermined reaction temperature, e.g., above 900° C. Therefore, the speed of material removal is very fast, for example, compared with the etch rate of glass using etchant solution at low temperature or below the reaction temperature.

The at least one edge provides at least one feature which may be a chamfer, a bevel, a groove, and/or a hole.

In some examples, the at least one edge separates the workpiece into a plurality of smaller workpieces; in other words, the edge provides a complete cut through the workpiece. In some other examples, the at least one edge does not separate the workpiece into a plurality of smaller workpieces; in other words, the edge provides an incomplete cut in the workpiece.

The shape of the at least one edge or feature may be defined and produced by a predetermined irradiation profile which defines at least one irradiation parameter, e.g., laser irradiation exposure duration and/or laser power, for each of a plurality of positions within the area to be irradiated. The predetermined irradiation profile may include other irradiation parameters, e.g., path, speed and/or spot size of laser irradiation. Accordingly, a processed workpiece may be provided with different features and/or feature shapes.

FIG. 2 illustrates an embodiment wherein a process produces a chamfered feature 203 with an arbitrary shape on the workpiece 202 by controlling the irradiation profile, e.g., laser exposure time position profile 201. The depth of the material being removed at a position depends on the laser irradiation exposure duration or laser exposure time at that position. The longer the exposure time, the deeper the depth. By scanning the laser beam over the workpiece 202 with a position dependent exposure time profile, a chamfered feature 203 with arbitrary shape and depth can be created. In some applications or examples, the laser parameters can be adjusted to get a complete cut through the workpiece at some positions and/or incomplete cut through the workpiece at some other positions.

The depth of the material being removed at a position depends on the total laser fluence focused on that position. The higher laser fluence delivered the more chemical is heated and thus the deeper the material removed. The total laser fluence is proportional to the laser power, the exposure time. By adjusting the laser power and the exposure time, the removal depth can be determined.

The 3D (three-dimensional) spatial resolution of the chamfered feature depends on the laser focus spot size, the laser power, the exposure time profile and the scanning or irradiation parameters (scanning path and speed). By controlling these parameters, the resolution and the surface smoothness of the chamfer and the cut can be defined.

In some embodiments, a workpiece processing method may comprise: producing at least one first edge at a first side of a workpiece (as described in the foregoing paragraphs), and producing at least one second edge at a second side of the workpiece. The first side and the second side may be same, opposed, or adjacent sides of the workpiece. In certain examples, the first edge and the second edge adjoin each other but do not cut or separate the workpiece into multiple smaller workpieces. In certain examples, the first edge and the second edge adjoin each other and cut or separate the workpiece into smaller workpieces.

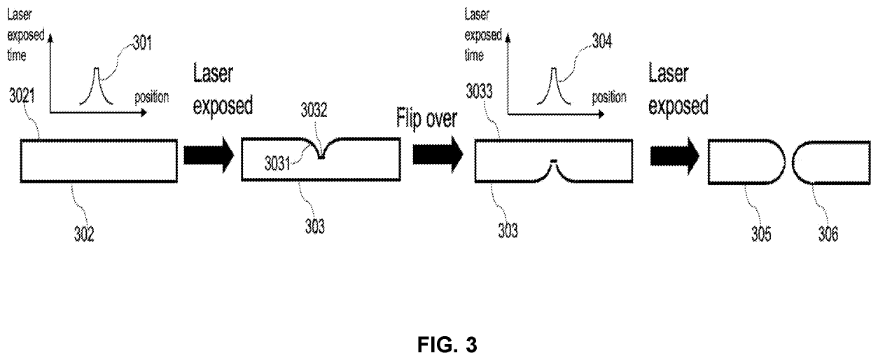

FIG. 3 shows an embodiment of the invention in which a process produces a cut and chamfers at opposed sides of a workpiece 302. A chemical, e.g., first chemical, is first deposited on the first side, e.g., first surface 3021, of the workpiece 302. The laser beam is then scanned over the surface 3021 of the workpiece 302 according to a first irradiation profile, e.g., exposure time profile 301, to induce a first chemical reaction to create at least one first edge, e.g., chamfered feature 3031 and a deep groove along the cut position 3032. The workpiece is then flipped over or re-orientated. The second side, e.g., second surface 3033, is then deposited with a chemical, e.g., second chemical, and exposed to laser irradiation according to a second irradiation profile, e.g., exposure time profile 304, to induce a second chemical reaction to create at least one second edge.

According to some examples of FIG. 3, the second edge adjoins the first edge to provide a complete cut to the workpiece 303, hence separating the workpiece into two smaller workpieces 305 and 306 with the desired chamfered features on both sides. The workpiece 302 is thus chamfered and cut in one manufacturing operation without a need to transfer the workpiece from a cutting machine to a chamfering machine. However, in some other examples (not shown), the second edge adjoins the first edge to provide a partial cut to the workpiece 303, hence the workpiece remains unseparated. Some of such examples may include the formation of non-through holes from opposed sides of the workpieces wherein the non-through holes may be aligned or disaligned.

According to some examples of FIG. 3, the first chemical and the second chemical are the same; the first reaction temperature and the second reaction temperature to induce the chemical reactions may be the same. However, in some other examples, the first chemical and the second chemical are different and the first reaction temperature and the second reaction temperature required to induce the first chemical reaction and the second chemical reaction for the two sides may be the same or different.

In various examples of FIG. 3, the first irradiation profile and the second irradiation profile may be the same or different depending on whether similar or different features or shapes at the edges are desired. Accordingly, the first edge and the second edge may provide a same feature or different features, which may be a chamfer, a bevel, a groove, and/or a hole. The shape of each feature may be the same or different. Each of these features may be an incomplete or complete cut through the workpiece.

According to some embodiments, a workpiece processing method may comprise iteratively producing at least one first edge at an area of a workpiece to increase dimension, e.g., depth, of the at least one first edge until a desired dimension, e.g., depth, at the same area is produced.

A thin layer of deposited chemical helps to increase the resolution of the chamfering process. However, as the removal depth increases more chemical is required. Therefore, each material removal cycle can produce a limited removal depth. The removal cycle can be repeated to increase the depth while keeping the resolution high.

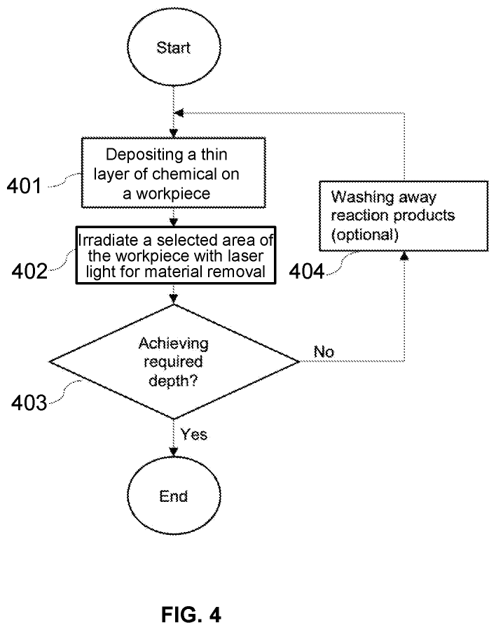

FIG. 4 shows a flow chart describing multiple chemical depositing and laser exposure cycles for increasing the removal depth, according to an embodiment. Operation 401 provides a thin layer of chemical on the workpiece. This provision may include depositing a layer of the chemical on the workpiece or immersing the workpiece in a reservoir of chemical such that a layer of the chemical is applied to the workpiece surface to be processed. The thickness of this layer can be optimized for the resolution and the machining speed. Operation 402 provides laser irradiation, e.g., scans the laser beam, over a selected area of the workpiece surface to heat the chemical and the workpiece at the selected area, and to remove a layer of the workpiece material at the selected area following a predefined path and exposure time position profile. Operation 403 checks or ascertains if the desired depth of removal is achieved or not, e.g., by ascertaining a dimension of the removal depth or a remaining dimension of the processed workpiece, and subsequently comparing the ascertained dimension against a predetermined dimension value. If the desired depth is not achieved, e.g., the ascertained dimension of the removal depth is below a predetermined dimension value or the remaining dimension of the processed workpiece is above a predetermined dimension value, the removal cycle is repeated at the same selected area of the workpiece. Operation 404, which is optional, clears, e.g., washes away, the reaction product, e.g., removed layer or portion, from the workpiece before starting a new or subsequent removal cycle. Operation 404 may include providing a water jet to remove the reaction product from the workpiece surface.

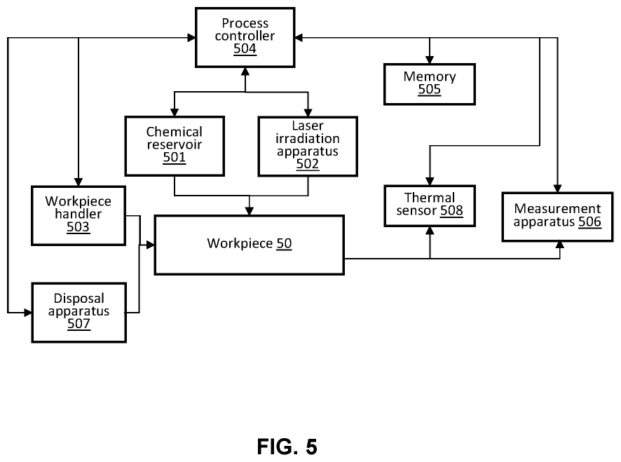

FIG. 5 shows a block diagram of a workpiece processing system according to various embodiments of the invention. The system may comprise at least a chemical reservoir 501, a laser irradiation apparatus 502, and a workpiece handler 503. In some embodiments, the system may further comprise a process controller 504 and a memory 505 communicably coupled thereto. In some embodiments, the system may further comprise a measurement apparatus 506. In some embodiments, the system may further comprise a disposal apparatus 507. In some embodiments, the system may further comprise a thermal sensor 508, e.g., thermal camera. In some embodiments, the system may comprise a combination of at least some of the foregoing embodiments. The interconnecting arrows in FIG. 5 are illustrative of signal/data flow and/or operational relationship but are not restrictive to that as illustrated.

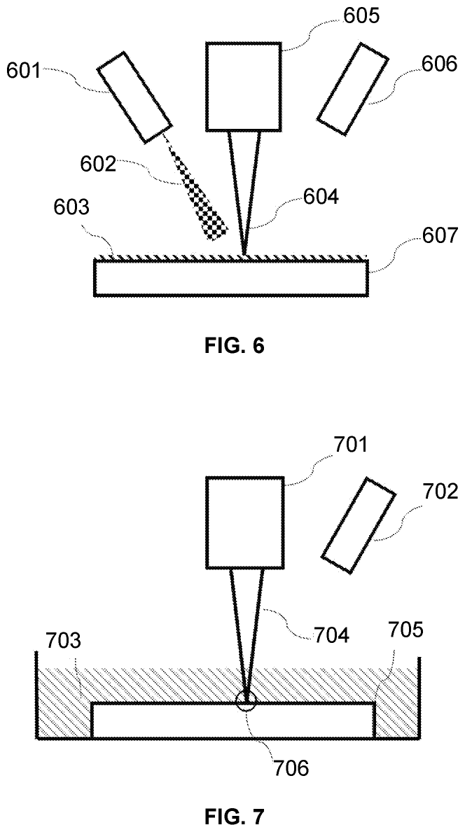

The chemical reservoir 501 is configured to provide a chemical on a selected area on a selected side of a workpiece 50. The chemical reservoir may be provided in different implementations, e.g., chemical dispenser 601 in FIG. 6 or chemical pool 701 in FIG. 7, which will be described in later paragraphs.

The laser irradiation apparatus 502 (or referred to as laser) is configured to irradiate laser light on a chemical which is applied to a selected area of a workpiece surface 50. The laser light is configured to heat the chemical and the workpiece at the selected area to a reaction temperature to induce a chemical reaction between the chemical and the workpiece 50 at the selected area to cause removal of a portion of the workpiece material at the selected area to produce the at least one edge.

The laser irradiation apparatus 502 may provide carbon dioxide (CO₂) laser or other types of lasers which emit wavelength at which the chemical is absorptive. Benefits of using CO₂ laser include the high absorption of sodium hydroxide, potassium hydroxide, glass as well as sapphire such as at a wavelength of 10.6 μm. In addition, strong absorption of water at this wavelength also benefits the heating process when the chemical is in solution form.

The workpiece handler 503 is configured to arrange a selected side of the workpiece 50 within operational reach of the chemical reservoir and the laser irradiation apparatus. For example, the workpiece handler 503 may arrange a selected side of the workpiece 50 relative to the chemical reservoir 501 to receive a chemical therefrom and further configured to simultaneously or subsequently arrange the same selected side of the workpiece 50 relative to the laser irradiation apparatus 502 to receive the laser light therefrom.

In certain examples, the workpiece handler 503 may be further configured to flip or orientate the workpiece 50 so that an opposed side or another selected side of the workpiece 50 may be arranged within operational reach of at least the chemical reservoir 501 and the laser irradiation apparatus 502 at the same or different times.

In certain examples, the workpiece handler 503 may be further configured to arrange the workpiece 50 within operational reach of the measurement apparatus 506 (optional), disposal apparatus 507 (optional), and/or thermal sensor 508 (optional) which will be described in later paragraphs.

A process controller 504 may be communicably coupled to the laser irradiation apparatus 502 and configured to operate or control the laser light based on a predetermined irradiation profile as described above. The process controller 504 may be communicably coupled to the workpiece handler 503 to operate or control the workpiece handler 503. The process controller 504 may be communicably coupled to the measurement apparatus 506 (optional), disposal apparatus 507 (optional), and/or thermal sensor 508 (optional) to operate or control these apparatuses.

The process controller 504 may be, for example and without limitation, a processor, microcomputer, minicomputer, server, mainframe, laptop, or any other programmable device or computer apparatus configured to transmit, process, and/or receive data.

A memory 505 for storing at least the predetermined or other irradiation profiles and any other instructions may be communicably coupled to the process controller 504.

The memory 505 may be include any means for storing software, including a hard disk, an optical disk, floppy disk, ROM (read only memory), RAM (random access memory), PROM (programmable ROM), EEPROM (electrically erasable PROM) and/or other computer-readable memory media.

A measurement apparatus 506 may be configured to ascertain a dimension, e.g., depth, of the at least one edge and transmit the ascertained dimension to the process controller 504 communicably coupled thereto. The process controller 504 is configured to compare the ascertained dimension reading against a predetermined dimension value which may be stored in the memory 505. If the ascertained dimension reading is below the predetermined dimension value, the process controller 504 is configured to cause at least the chemical reservoir 501, the laser irradiation apparatus 502, and/or the workpiece handler 503 to repeat production of the at least one edge at the same area to increase the dimension of the at least one edge or removal depth. The process controller 504 may be configured to operate the measurement apparatus 506 to ascertain dimension of the at least one edge after each removal cycle or production of edge, receive the dimension reading, ascertain a need for a subsequent removal cycle or production of edge based on a comparison of the dimension reading and a predetermined or desired dimension value.

A disposal apparatus 507 may be configured to clear the reaction products or removed portion away from the workpiece 50 if the ascertained dimension of the at least one first edge is below a predetermined dimension or after each removal cycle. In particular, the process controller 504 is configured to cause the disposal apparatus 507 to clear the reaction products away from the workpiece 50 if the ascertained dimension of the at least one first edge is below a predetermined dimension value.

A thermal sensor 508 may be configured to ascertain a temperature of the chemical and/or workpiece at the hot spot which is receiving laser irradiation and transmit the ascertained temperature reading to the process controller 504. The process controller 504 may be configured to compare the ascertained temperature reading against a predetermined reaction temperature value which may be stored in the memory 505 and control the laser irradiation apparatus 502 accordingly, e.g., adjust laser power to adjust heat delivery to the hot spot.

In certain examples, the laser irradiation apparatus 502 may include or may be communicably coupled to one or more of the following: a mirror apparatus configured to steer or direct the laser light over the a selected area of the workpiece 50 to shape the at least one edge; an optical imaging apparatus configured to shape the laser light to produce a shaped laser beam and irradiate the shaped laser beam at the workpiece 50 to shape the at least one edge; and a motorised staging apparatus configured to translate or orientate the workpiece 50 relative to the laser light to shape the at least one edge.

The mirror apparatus may include Galvano mirror(s).

The optical imaging apparatus may include a laser beam shaper such as diffractive optic element (DOE), spatial light modulator (SLM).

The motorised staging apparatus may be configured to move the workpiece in three-dimensional space in x, y, and z directions.

FIG. 6 illustrates an embodiment of the invention. A chemical dispenser 601 may be used for depositing a layer of chemical 603 on a surface of a workpiece 607. A laser beam 604 from a laser 605 is scanned over the chemical 603 to selectively heat it to the desired reaction temperature which may be in the range of 900° C. to 1000° C. The locally heated chemical reacts with the workpiece material and removes the workpiece material at the selectively heated position and hence creates desired chamfered features and cuts. A thermal camera or sensor 606 may be installed to monitor the temperature for process optimization.

FIG. 7 illustrates an embodiment of the invention in which a workpiece 705 is immersed in chemical 703. The chemical 703 can be in liquid form or solution form. A laser beam 704 from a laser 701 is focused on the workpiece surface and heats the chemical or both the chemical and the workpiece at a focus spot 706 to the reaction temperature. The chemical reaction removes the workpiece material at the focus spot. Desired chamfers and cuts can be created by scanning the laser beam 704 following a predefined path and exposure time position profile. A thermal sensor, e.g., thermal camera 702, can be used for monitoring the temperature.

In various embodiments, a single component may be replaced by multiple components, and multiple components may be replaced by a single component, to perform a given function or functions. This may apply at least to the process controller and/or memory.

Embodiments of the invention provide various advantages including but not limited to the following.

The invention provides methods to cut and chamfer glass or glass-like workpieces in one combined operation or process, unlike conventional methods which require separate cutting process and chamfering process. This reduces the time required for transferring the workpiece from cutting operation to chamfering operation. It also saves space and cost since no additional machine is required for separate cutting and chamfering processes.

In the invention, workpiece material is selectively removed through a fast chemical reaction induced by locally heating to high temperature (at least 900° C.) using a laser beam. The chemical reaction takes place immediately once the reaction temperature is reached, unlike conventional slow etching process which is based on chemical corrosion of the workpiece with an etching solution at low temperature (below 200° C.) and which may take hours to etch 1 mm depth of material.

In the invention, the laser parameters and the scanning parameters can be varied to produce chamfers and cuts of different sizes and shapes. Moreover, the physical parameters of the chemical and the laser parameters can be varied to obtain a desired surface smoothness.

The invention does not require use of expensive picosecond or femtosecond lasers. The laser for heating the chemical in the invention can be low cost nanosecond or even CW lasers. Speed of the laser based material processing is normally limited by the laser power. However, with the availability of high power (up to few tens of kilo Watts) nanosecond or CW lasers, the manufacturing operation using the methods of the invention would be scalable to run at high speed and give high throughput, e.g., unit per hour (UPH).

It is to be understood that the embodiments and features described above should be considered exemplary and not restrictive. Many other embodiments will be apparent to those skilled in the art from consideration of the specification and practice of the invention. Furthermore, certain terminology has been used for the purposes of descriptive clarity, and not to limit the disclosed embodiments of the invention.

1. A workpiece processing method comprising:
producing at least one first edge at a workpiece, which is glass or glass-like, by:
providing a first alkaline chemical on a first area on a first side of the workpiece; and
heating the first alkaline chemical at the first area to a first reaction temperature using irradiation of a first laser light, thereby inducing a first chemical reaction between the first alkaline chemical and the workpiece at the first area and causing removal of a first portion of the first area to produce the at least one first edge.

2. The method of claim 1, wherein the first reaction temperature is between 900 degree Celsius and 1000 degree Celsius.

3. The method of claim 1, wherein heating the first alkaline chemical at the first area to the first reaction temperature using irradiation of the first laser light includes
irradiating the first laser light based on a predetermined irradiation profile which defines at least one irradiation parameter, including laser irradiation exposure duration and/or laser power, for each of a plurality of positions within the first area, wherein the predetermined irradiation profile is configured to produce a predetermined shape at the at least one first edge.

4. The method of claim 1, wherein producing the at least one first edge at the workpiece further includes ascertaining a dimension of the at least one first edge,
wherein the method further comprises:
if the ascertained dimension of the at least one first edge is below a predetermined dimension value, repeating the step(s) of producing the at least one first edge at the first area of the workpiece to increase the dimension of the at least one first edge.

5. The method of claim 1, wherein after producing the at least one first edge at the workpiece, the method further comprising:
producing at least one second edge at the workpiece by:
providing a second alkaline chemical on a second area on a second side of the workpiece; and
heating the second alkaline chemical at the second area to a second reaction temperature using irradiation of a second laser light, thereby inducing a second chemical reaction between the second alkaline chemical and the workpiece at the second area and causing removal of a second portion of the second area to produce the at least one second edge which adjoins the at least one first edge.

6. The method of claim 5, wherein the at least one first edge and the at least one second edge separate the workpiece into a plurality of smaller workpieces.

7. The method of claim 1, wherein the workpiece includes quartz, glass-ceramic, or sapphire.

8. The method of claim 1, wherein the at least one first edge includes a chamfer, a bevel, a groove, and/or a hole.

9. The method of claim 1, wherein heating the first alkaline chemical at the first area to the first reaction temperature using irradiation of the first laser light includes one of the following:
using at least one mirror, steering the first laser light over the first area of the workpiece to shape the at least one first edge;
shaping the first laser light to produce a shaped first laser beam and irradiating the shaped first laser beam at the workpiece to shape the at least one first edge; and
translating the workpiece relative to the first laser light to shape the at least one first edge.

10. A workpiece processing system comprising:
a chemical reservoir configured to provide a first alkaline chemical on a first area on a first side of a workpiece, which is glass or glass-like;
a laser irradiation apparatus configured to irradiate a first laser light on the first alkaline chemical at the first area, wherein the first laser light is configured to heat the first alkaline chemical at the first area to a first reaction temperature to induce a first chemical reaction between the first alkaline chemical and the workpiece at the first area, wherein the first chemical reaction is to cause removal of a first portion of the first area to produce the at least one first edge; and
a workpiece handler configured to arrange the first side of the workpiece within operational reach of the chemical reservoir and the laser irradiation apparatus.

11. The workpiece processing system of claim 10, wherein the first reaction temperature is between 900 degree Celsius and 1000 degree Celsius.

12. The workpiece processing system of claim 10, further comprising:
a process controller communicably coupled to the laser irradiation apparatus and configured to operate the first laser light based on a predetermined irradiation profile which defines at least one irradiation parameter, including laser irradiation exposure duration and/or laser power, for each of a plurality of positions within the first area, wherein the predetermined irradiation profile is configured to produce a predetermined shape at the at least one first edge.

13. The workpiece processing system of claim 12, further comprising:
a measurement apparatus communicably coupled to the process controller and configured to ascertain a dimension of the at least one first edge and transmit the ascertained dimension to the process controller;
wherein the process controller is configured to cause the chemical reservoir and the laser irradiation apparatus to repeat production of the at least one first edge at the first area to increase the dimension of the at least one first edge if the ascertained dimension of the at least one first edge is below a predetermined dimension.

14. The workpiece processing system of claim 12, further comprising:
a disposal apparatus communicably coupled to the process controller and wherein the process controller is configured to cause the disposal apparatus to clear the first portion away from the workpiece if the ascertained dimension of the at least one first edge is below a predetermined dimension.

15. The workpiece processing system of claim 12, further comprising:
a thermal sensor communicably coupled to the process controller and configured to ascertain a temperature of the first alkaline chemical at the first area and transmit the ascertained temperature reading to the process controller,
wherein the process controller is configured to control the laser irradiation apparatus according to the ascertained temperature reading relative to the first reaction temperature.

16. The workpiece processing system of claim 10, wherein the workpiece handler is further configured to arrange a second side of the workpiece within operational reach of the chemical reservoir and the laser irradiation apparatus,
wherein the chemical reservoir is configured to provide a second alkaline chemical on a second area on the second side of the workpiece,
wherein the laser irradiation apparatus is configured to irradiate a second laser light on the second alkaline chemical at the second area, wherein the second laser light is configured to heat the second alkaline chemical at the second area to a second reaction temperature to induce a second chemical reaction between the second alkaline chemical and the workpiece at the second area, wherein the second chemical reaction is to cause removal of a second portion of the second area to produce the at least one second edge which adjoins the at least one first edge.

17. The workpiece processing system of claim 16, wherein the at least one first edge and the at least one second edge separate the workpiece into a plurality of smaller workpieces.

18. The workpiece processing system of claim 10, wherein the workpiece includes quartz, glass-ceramic, or sapphire.

19. The workpiece processing system of claim 10, wherein the at least one first edge includes a chamfer, a bevel, a groove, and/or a hole.

20. The workpiece processing system of claim 10, wherein the laser irradiation apparatus includes one of the following:
a mirror apparatus configured to steer the first laser light over the first area of the workpiece to shape the at least one first edge;
an optical imaging apparatus configured to shape the first laser light to produce a shaped first laser beam and irradiate the shaped first laser beam at the workpiece to shape the at least one first edge; and
a motorised staging apparatus configured to translate the workpiece relative to the first laser light to shape the at least one first edge.
